(19) United States
(12) Patent Application Publication
(10) Pub. No.: US 2009/0272640 A1
(43) Pub. Date: Nov. 5, 2009

(54) ELECTRICAL SWITCH WITH DETECTION AND AN ASSEMBLY COMPRISING SUCH A DETECTING SWITCH

(75) Inventors: Jean-Christophe Villain, Dole (FR); Michel Cour, Sampans (FR)

Correspondence Address: PEPPER HAMILTON LLP, ONE MELLON CENTER, 50TH FLOOR, 500 GRANT STREET, PITTSBURGH, PA, 15219, US

(73) Assignee: COACTIVE TECHNOLOGIES, INC., Newton, MA (US)

(21) Appl. No.: 12/433,509

(22) Filed: Apr. 30, 2009

(30) Foreign Application Priority Data
Apr. 30, 2008 (FR) 0852922

(51) Int. Cl. H01H 13/14

(52) U.S. Cl. 200/520; 200/341; 200/344

(57) ABSTRACT

An electrical switch including a supporting base, a top button mounted to the supporting base wherein the top button has a top face configured to receive a first force for actuating the electrical switch, and a detecting interrupter mounted to the top button configured to detect contact on the top face as well as to establish a signal representative of any detection of the contact on the top button when the first force is greater than or equal to a first threshold value. The detecting interrupter further includes a blade configured to deform elastically under the top button to establish the signal and further configured to exert a resistance force on the top button, wherein the resistance force increases continuously while the first force is exerted.

### CROSS REFERENCE TO RELATED APPLICATIONS

This application claims the priority benefit of France Patent Application no. 0852922 filed Apr. 30, 2008.

### BACKGROUND

The present invention relates to electrical switches. More specifically, the present invention relates to electrical switches capable of detecting contact of a control member of an electrical switch.

An exemplary conventional electrical switch comprises a supporting base, at least two electrical contacts mounted on the supporting base, a switching interrupter mounted to the at least two electrical contacts and a top button mounted to the switching interrupter. To actuate the switch, a user uses a control member, such as one of his fingers or a similar pointing device, which the user places in contact on the top face of the button. The user exerts a control action or force on the top face of the button, causing the interrupter to switch.

Because of its relatively simple construction, the switch may be arranged in numerous locations. However, when the eyes of the user are not directed toward the switch and the switch is controlled blind, it is difficult for the user to know if their finger is in contact with the switch which the user desires to actuate.

This is notably the case when the switch is installed in a motor vehicle. For safety reasons, the eyes of a driver of the motor vehicle are mainly directed forward. Therefore, the driver “searches” for the switch by feeling in the zone in which the switch is situated, e.g., on the vehicle's radio console.

When a switch forms part of a group of identical or similar switches, for example a keyboard, it is difficult to distinguish by touch alone which switch a user is in contact with. It has been proposed to add protuberances or other identifiable features on the top faces of switches making it possible to distinguish individual switches by touch.

However, distinguishing by touch is particularly difficult and requires great concentration on the part of the user. In addition, when the environment of the switch is subjected to vibrations, for example, when the switch is arranged in a moving vehicle, the tactile sensations are greatly disrupted by the vibrations, and may result in the user selecting an incorrect switch.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

In one general respect, the embodiments disclose an electrical switch. The electrical switch includes a supporting base, a top button mounted to the supporting base so as to be movable by sliding vertically relative to the supporting base, wherein the top button has a top face configured to receive a first force for actuating the electrical switch, the first force being exerted by a control member, a detecting interrupter mounted to the top button configured to detect contact of the control member on the top face as well as to establish a signal representative of any detection of the contact of the control member on the top button when the first force exerted by the control member is greater than or equal to a first threshold value, a plate mounted to the detecting interrupter and configured to be movable by sliding vertically relative to the supporting base, and a switching interrupter mounted to the supporting base to which the first force is transmitted indirectly by the plate, wherein the switching interrupter is configured to establish a switch path when the first force is greater than or equal to a second threshold value, wherein the second threshold value is greater than the first threshold value. The detecting interrupter further includes a blade configured to deform elastically under the top button to establish the signal and further configured to exert a resistance force on the top button, wherein the resistance force increases continuously while the first force is exerted by the control member.

In another general respect, the embodiments disclose a switch assembly. The switch assembly includes at least one switch mounted on a holder plate and a switch case

### BRIEF DESCRIPTION OF THE DRAWINGS

Aspects, features, benefits and advantages of the present invention will be apparent with regard to the following description and accompanying drawings, of which:

FIG. 1 illustrates a schematic representation of an exemplary switch;

FIG. 2 illustrates an exploded view of the exemplary switch of FIG. 1;

FIG. 3 illustrates a perspective view from below of the exemplary switch of FIG. 1;

FIG. 4 illustrates a perspective view of the exemplary switch of FIG. 1 wherein various components of the switch have been removed for clarity;

FIG. 5 illustrates a sectional view along a vertical plane of the exemplary switch of FIG. 1;

FIG. 6 illustrates an exploded view of additional embodiments of an exemplary switch;

FIG. 7 illustrates an exploded view of additional embodiments of an exemplary switch; and

FIGS. 8A-8E illustrate sectional views along a vertical plane of the exemplary switch illustrated in FIG. 7, illustrating various embodiments of mounting and actuating the exemplary switch.

### DETAILED DESCRIPTION

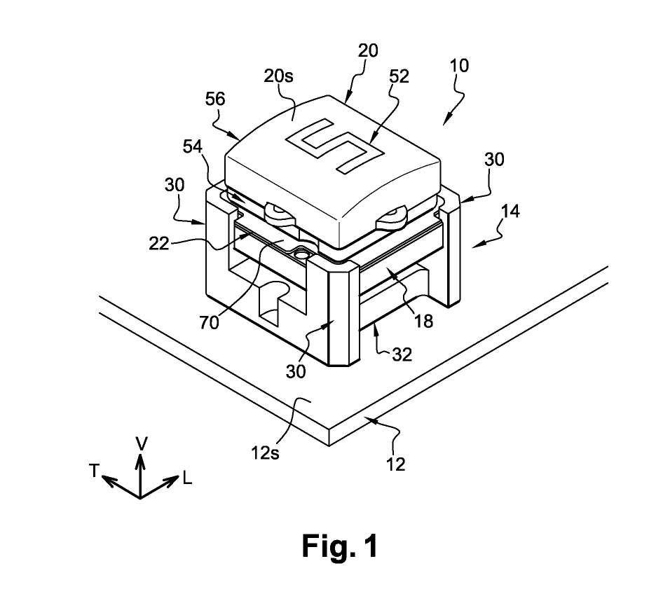

For purposes of the discussion below, the vertical, longitudinal and transverse orientations will be adopted according to the V, L, T coordinate system indicated in the figures, e.g., FIG. 1, and without reference to earth's gravity.

In the following description, identical, similar or analogous elements will be indicated by the same reference numbers.

The figures, specifically FIG. 1, illustrate an electrical switch 10 of the “pushbutton” type, which may be designed to be mounted on a component-holder plate 12. The switch 10 may include, along its general vertical axis corresponding to the axis V, a bottom supporting base 14. The bottom supporting base may be attached to a top face 12s of the component-holder plate 12 as well as a button 20. The button 20 may move relative to the bottom supporting base 14. A user may exert a force or control action on the button 20 in order to control the switch 10. In order to exert the control action, a control member, such as a finger of the user, may press on a top face 20s of the button 20 as the user exerts an actuation force on the button 20 with the control member.

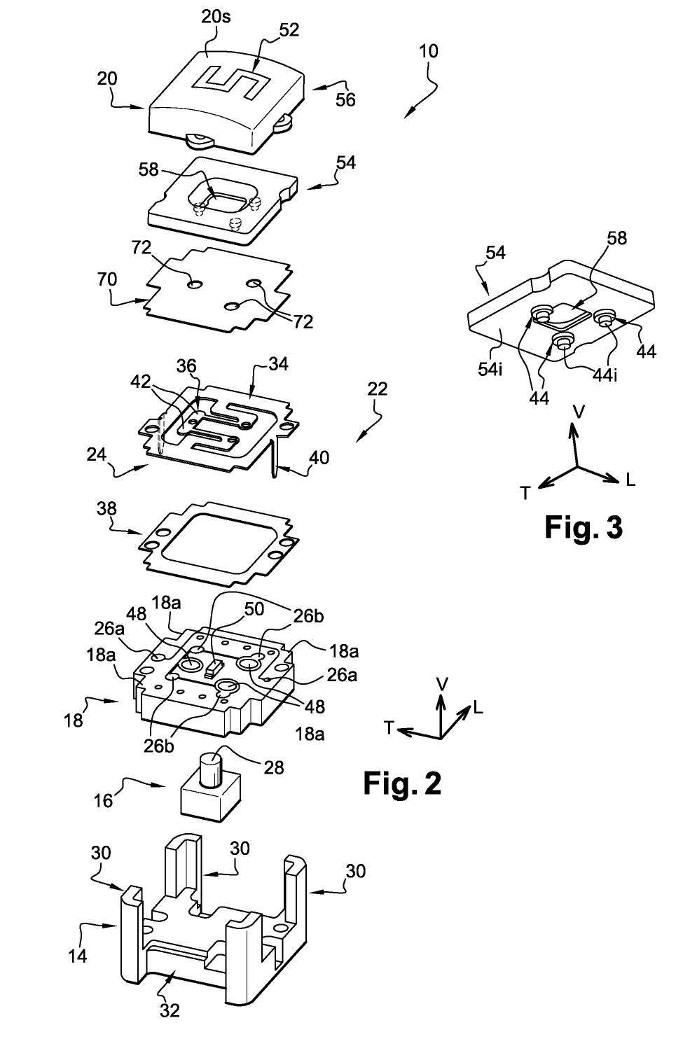

The switch 10 may also include a switching interrupter 16 (as shown in FIG. 2). The switching interrupter 16 may establish an associated switch path when the user exerts a control action on the button 20.

The switching interrupter 16 may be constructed such that it is capable of changing states in order to establish the switch path when the actuation force applied to the button 20 is greater than or equal to a determined threshold value. Additionally, when the switching interrupter 16 changes state, the switching interrupter 16 may produce a tactile sensation, e.g., a “click.” The tactile sensation may be transmitted to the button 20 so that the user can feel the tactile sensation.

The switching interrupter 16 may also include a top button 28 to which the actuation force is transmitted by button 20 as well as a contactor (not shown) which may establish the switch path in response to actuation of the top button 28. Before the change of state of the switching interrupter 16, the top button 28 may be in a high position and the contactor may be in a position in which the switch path is not established. The switching interrupter 16 may be constructed such that, when it is subjected to an actuation force weaker than the associated threshold value, the top button 28 is kept in the high position and the contactor is kept in its position in which the switch path is not established. Conversely, when the switching interrupter 16 may be subjected to an actuation force greater than or equal to the associated threshold value, the top button 28 moves downwards and the contactor establishes the associated switch path.

For example, the switching interrupter 16 may be constructed such that the top button 28 is in downwards abutment against the contactor when it is in the high position, and the contactor is capable of changing state suddenly when the actuation force becomes greater than or equal to the threshold value. During this change of state of the contactor, the switching interrupter 16 may produce the tactile sensation and the associated switch path may be established.

The switch 10 may also include a detecting interrupter 22. The detecting interrupter 22 may be constructed and configured to detect contact of a control member and button 20, and to establish an electrical signal representative of detecting the contact of the control member on the top face 20s of the button. This signal may then be transmitted to an electronic device (not shown) to allow the control of an electronic apparatus via switch 10. In this example, the contact of the control member on the top face 20s of the button 20 may be detected when the actuation force exerted by the control member on the button is greater than or equal to a determined threshold value which is less than the threshold value corresponding to the change of state of the switching interrupter 16.

In the following description, for clarification purposes, “first threshold value” will be used for the threshold value of the actuation force for which the detecting interrupter 22 establishes the associated switch path, and “second threshold value” will be used for the threshold value of the actuation force for which the switching interrupter 16 establishes the associated switch path. Therefore, in the above example, the first threshold value is less than the second threshold value. Preferably, the first threshold value may be determined such that the detecting interrupter 22 is activated when the actuation force is substantially equal to only the weight of the control member.

The detecting interrupter 22 may be constructed such that no tactile sensation is felt by the user during the activation of the detecting interrupter 22. As illustrated in FIG. 2, the detecting interrupter 22 may include a blade 24 which may be elastically deformable, under the action of the button 20. The blade 24 may deform between a rest position corresponding to no contact of the control member with the top face 20s of the button 20 or when the actuation force exerted on the button is less than the first threshold value, and a deformed position of detection when the actuation force exerted on the button is greater than or equal to the first threshold value.

The blade 24 may directly connect to the button 20 such that the actuation force exerted on the button is transmitted directly to the blade. When the user exerts the actuation force, the blade 24 may deform elastically and exert on the button 20 a resistant force which may be opposite to the actuation force. For the user to feel no tactile sensation when activating the detecting interrupter 22, the blade 24 may be constructed such that the resistant force increases continuously as the blade deforms. In addition, the stiffness of the blade 24 may be defined such that the maximum value of the resistant force, corresponding to the activation of the detecting interrupter 22, is weak enough not to be distinguished by the user. Therefore, the weak value of the resistant force makes it possible to have a relatively rapid detection of the contact of the control member on the top face 20s of the button 20, and makes it possible to produce no tactile sensation.

The detecting interrupter 22 may also at least two electrical contacts, in this example electrical contacts 26a and 26b, which may be electrically connected by the blade 24 in order to establish an electrical signal. To achieve this electrical signal, the blade 24 may be constructed of an electrically conductive material such as steel, copper or various other metals. The electrical contacts 26a and 26b may be arranged on a top face 18s of a plate 18 which may be positioned vertically beneath the button 20. The blade 24 may be positioned vertically above and at a distance from the top face 18s of the plate 18 such that a movable portion of the blade 24 and the button 20 are capable of moving downwards toward the plate 18 when the user exerts an actuation force.

According to another aspect of the detecting interrupter 22, when the actuation force is greater than or equal to the first threshold value, that is to say when the electrical signal is established, the movable portion of the blade 24 and the button 20 may be in abutment downwards against the top face 18s of the plate 18. Therefore, after the activation of the detecting interrupter 22, and when the actuation force exerted by the user increases, this actuation force may be transmitted directly to the plate 18.

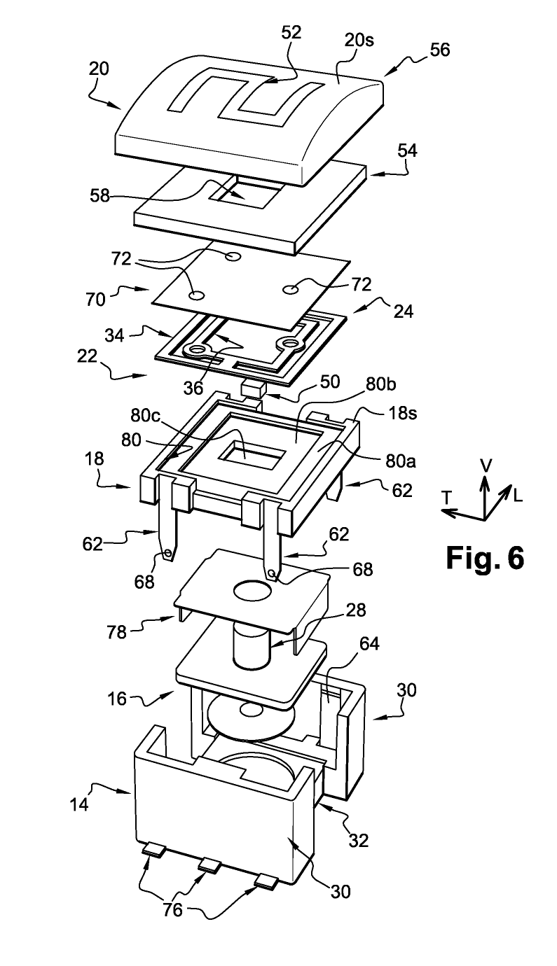

As can be seen in FIGS. 2 and 4, the blade 24 may include a horizontal metal plate which may include a fixed peripheral portion 34 and an elastically deformable central portion 36.

The central portion 36 of the blade may form the movable portion of the blade 24 as defined above. The central portion 36 may be deformed elastically, and may be designed so as not to produce a tactile sensation as defined above.

A spacer 38 may be arranged between the blade 24 and the plate 18 to hold the central portion 36 of the blade 24 at a uniform distance from the top face 18s of the plate 18. The spacer 38 may also hold the central portion 36 of the blade 24 at a distance from the electrical contacts 26a and 26b when the control member is not in contact with the top face 20s of the button 20 or when the control member exerts a force the value of which is less than the first threshold value on the top face of the button. The thickness of the spacer 38 may be relatively small, thereby making it possible to limit any travel of the button 20 relative to the plate 18 when the detecting interrupter 22 is actuated, and consequently making it possible to limit the sensation that the user may feel as a result of the actuation of the detecting interrupter.

The blade 24 may be electrically connected at all times to at least one first electrical contact 26a. As shown in FIGS. 2 and 4, the plate 18 may support several electrical contacts 26a to which the blade 24 may be connected at all times. These contacts will be designated hereinafter as the first electrical contacts 26a.

The blade 24 may connect to the first electrical contacts 26a by means of the peripheral portion 34 which may comprise several lugs 40, each of which may be associated with a first electrical contact 26a. Each lug 40 may extend vertically downwards from the outer edge of the peripheral portion 34 to the first electrical contact 26a. The connection of each lug 40 with the first associated contact 26a may be made, for example, by soldering. This connection may make it possible to achieve an electro-mechanical attachment of the blade 24 with the plate 18. The central portion 36 of the blade 24 may be the portion of the blade 24 that is capable of deforming elastically under the actuation force, and it may also be capable of coming into contact with at least one second electrical contact 26b. To continue the above example shown in FIGS. 2 and 4, the plate 18 may support a plurality of electrical contacts 26b with which the central portion 36 of the blade 24 is capable of coming into contact, which will be called hereinafter the second electrical contacts 26b.

The second electrical contacts 26b may connect together in such a way that even if the central portion 36 of the blade comes into contact with only one second electrical contact 26b, the electrical signal associated with the detecting interrupter 22 may nevertheless be established.

To come into contact with the second electrical contacts 26b, the central portion 36 may include several bearing fingers 42, each of which may be associated with a second electrical contact 26b.

Each finger 42 may therefore be situated vertically in line with and at a distance from the second associated electrical contact 26b.

Since the spacer 38 may be arranged vertically between the blade 24 and the plate 18, the spacer 38 may form an annular strip open in the middle similar to the peripheral portion 34 of the blade 24. Therefore, the central portion 36 of the blade 24 may be capable of passing through the central opening of the spacer 38. The central portion 36 of the blade 24 may form a horizontal strip, the mid-line of which follows a complex path, which in this instance is in the shape of a W. The two ends 36a of the central portion 36 may connect to the peripheral portion 34.

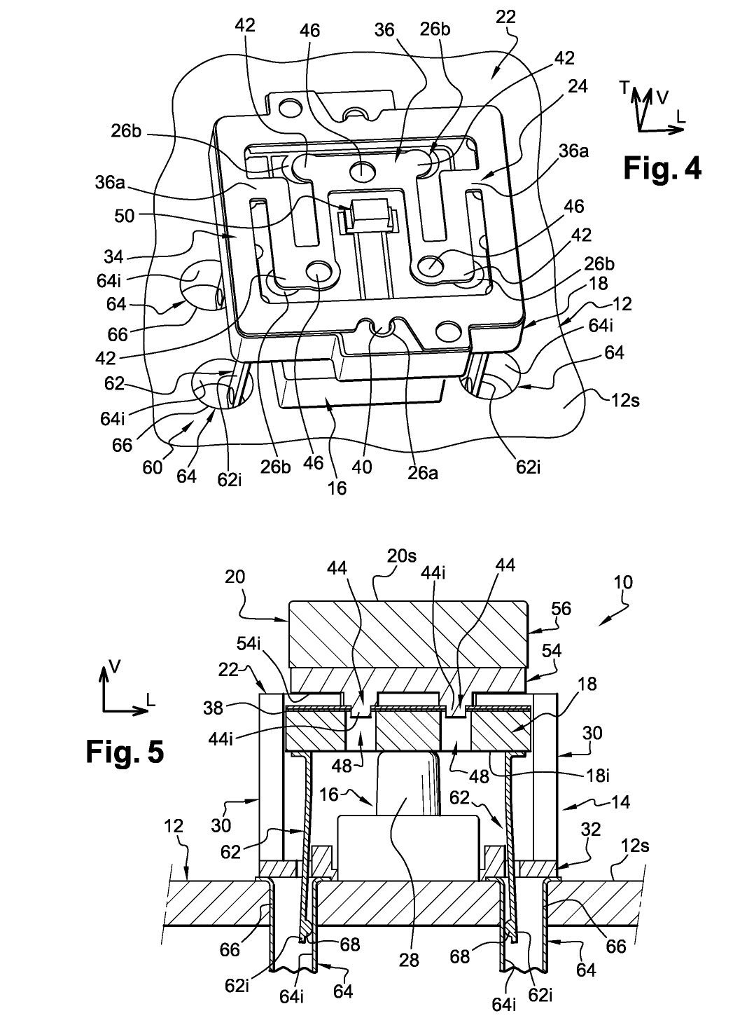

As discussed above, the central portion 36 of the blade 24 may deform elastically downwards when the button 20 is subjected to the actuation force, thereby establishing the electrical signal. According to a preferred embodiment of the detecting interrupter 22, the button 20 may attach to the central portion 36 of the blade 24. As shown in FIG. 3, the button 20 may include bottom feet 44, in this instance three bottom feet, which may attach to the central portion 36 at their bottom ends 44i, in this instance by swaging. The central portion 36 of the blade 24 may include several holes 46, each of which is associated with a foot 44 and which are traversed by the bottom ends 44i of the feet 44. A portion of the bottom end 44i of each foot 44 may deform radially in a permanent manner such that the material thus deformed rests against the bottom face of the central portion 36 of the blade 24.

Such a method of connecting the bottom end 44i of each foot 44 to the central portion 36 of the blade 24 may make it possible to have an attachment of the button 20 to the blade 24. In addition, in this example, the button 20 may be made in two portions; it includes a bottom portion 54, the bottom face 54i of which supports the feet 44, and a top portion 56 on which the actuation member presses.

According to another aspect of the detecting interrupter 22, the blade 24 may be constructed such that it is only capable of deforming vertically in order to prevent any horizontal movement of the central portion 36 of the blade 24. Consequently, the blade 24 may hold the button 20 in a predefined horizontal position above the plate 18, and the deformable central portion 36 of the blade 24 provides guidance of the button 20 while sliding vertically downwards relative to the plate 18.

The switch 10 may be constructed such that the plate 18 may mount so as to be able to move by sliding vertically downwards relative to the base 14. Similarly, the plate 18 may be positioned vertically between the button 20 and the switching interrupter 16. The plate 18 may transmit the actuation force to the switching interrupter 16 when the button 20 is in downwards abutment against the top face 18s of the plate. Reciprocally, the plate 18 may transmit the tactile sensation produced by the switching interrupter 16 to the button 20 when it changes state. To transmit the tactile sensation, the plate 18 may rest directly downwards on the button 28 of the switching interrupter 16.

The switching interrupter 16 may be constructed such that, before its change of state, the plate 18 may be immobilized in a high position, for example, and as described above, the contactor may perform this immobilization of the button 28 and of the plate 18. Then, during the change of state of the switching interrupter 16, as described above, when the actuation force becomes greater than or equal to the second threshold value, the button 28 may move downward, allowing the plate 18 to move downward to a low position corresponding to the actuation position of the switching interrupter for which the associated switch path is established.

Similarly, as the plate 18 may press downward on the button 28 and the button 20 may press downward on the plate 18, the tactile sensation produced by the switching interrupter 16 during its change of state, may transmit to the button 20 by means of the plate 18.

In this example, the plate 18 may be flat, horizontally positioned and have a rectangular parallelepiped shape. The plate 18 may be guided as it slides vertically by the base 14 which, for this purpose, may include vertical uprights 30, each of which is arranged at a corner 18a of the plate 18 and which extends vertically upwards from a flat bottom portion 32 of the base 14. In this example, each upright 30 may have a shape of an angle post, e.g., the horizontal section of each upright forms a V, the branches of which are of the same length and are perpendicular to each other. Each upright 30 may therefore receive a corner 18a of the plate 18. The assembly of the uprights 30 then may define a vertical duct in which the plate 18 is received and in which the plate 18 cannot move horizontally.

As discussed above, when the detecting interrupter 22 has been actuated, the button 20 may be in downward abutment against the top face 18s of the plate 18 by means of the central portion 36 of the blade 24. In addition, the feet 44 of the button 20 may pass through the central portion 36 of the blade 24 such that the bottom end 44i of each foot 44 is situated partly below the central portion 36 of the blade 24. To prevent the bottom ends 44i of the feet 44 from disrupting the contact of the central portion 36 of the blade 24 with the second electrical contacts 26b, the plate 18 may include various orifices 48 that are made in the top face 18s of the plate 18 and in which the feet 44 of the button 20 are capable of being received.

In the example shown in FIG. 2, the plate 18 may include several orifices 48, each of which is associated with a foot 44. Each orifice 48 may be constructed such that the associated foot 44 is free to slide vertically in the orifice 48 when the button 20 slides vertically relative to the plate 18. Each orifice 48 may therefore be positioned vertically in line with the associated foot 44.

According to another aspect of the switch 10, a light source 50, such as for example a light-emitting diode, may mount on the top face 18s of the plate 18. As can be seen in FIGS. 2 and 4, the light source 50 may be positioned horizontally at the centre of the plate 18. The light produced by the light source 50 may illuminate at least partly the top face 20s of the button 20. For this purpose, the button 20 may include means 52 for conducting the light produced by the light source to the top face 20s of the button 20. These means 52 for conducting the light may be designed or arranged to form a figure, a character or a sign on the top face 20s of the button 20.

As discussed above, the button 20 may be constructed in two portions, a bottom portion 54 and a top portion 56. To allow the light to be conducted, the top portion 56 of the button may include the means 52 for conducting the light and the bottom portion 54 may include a central opening 58 in which the light source 50 is received and through which the light produced may illuminate the means 52 of conduction.

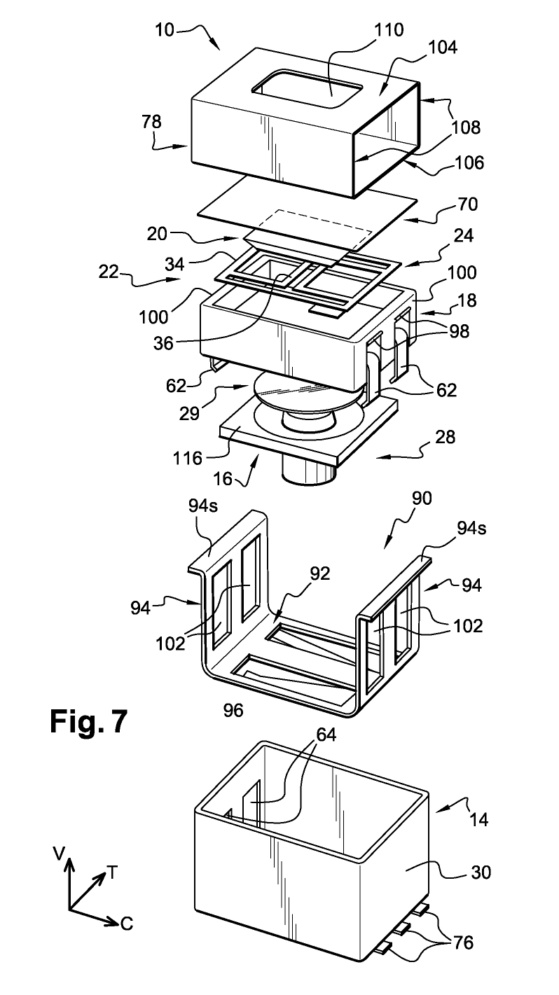

The top face 18s of the plate 18 may support the first electrical contacts 26a, the second electrical contacts 26b and the light source 50. For the switch 10 to operate, these elements may be electrically connected to electrical circuits (not shown) of the component-holder plate 12. The plate 18 may be mounted so to be able to move by sliding vertically relative to the base 14, and consequently relative to the component-holder plate 12, so the switch 10 may include movable means 60 for electrically connecting the plate 18 to the component-holder plate 12. In this embodiment as shown in FIG. 5, these movable connection means 60 may comprise several movable conductors 62 which are supported by the plate 18 as well as fixed conductors 64 which are supported by the component-holder plate 12 and each of which is associated with a movable conductor 62.

Each movable conductor 62 may be associated with an electrical contact 26a, 26b or with a pole of the light source 50. Each movable conductor may include a metal blade which extends vertically downwards from the bottom face 18i of the plate 18. Each fixed conductor 64 may include a tubular element with a vertical main axis which may mount in an associated hole 66 of the component-holder plate 12. The bottom end 62i of each movable conductor 62 may be received in the tubular duct, delimited by the associated fixed conductor 64, and it may come into sliding contact on the inner cylindrical face 64i of the fixed contact 64.

Preferably, each movable contact 62 may be subjected to a permanent elastic deformation, which makes it possible to exert a permanent pressing force on the bottom end 62i of the movable contact 62 onto the inner face 64i of the associated fixed contact 64. In addition, in this instance, the bottom end 62i of the movable contact 62 may include a boss 68 for resting on the inner face 64i of the associated fixed contact 64.

The switch 10 may be designed to be used in all types of environments. Because of the thinness of the spacer 38, any element that could be inserted between the blade 24 and the plate 18 may harm the correct operation of the detecting interrupter 22. This is why a protective film 70, made for example of polytetrafluoroethylene (Teflon®), may entirely cover the blade 24 in a sealed manner. This film 70 may include holes 72 associated with the feet 44 of the button 20 and that are closed off by the feet 44 by the simultaneous swaging of the bottom ends 44i of the feet 44 onto the blade 24 and onto the film 70. The film 70 may cover the light source 50 and it may be made of a light-permeable material in order to allow tile light produced by the light source 50 to reach the top face 20s of the button 20.

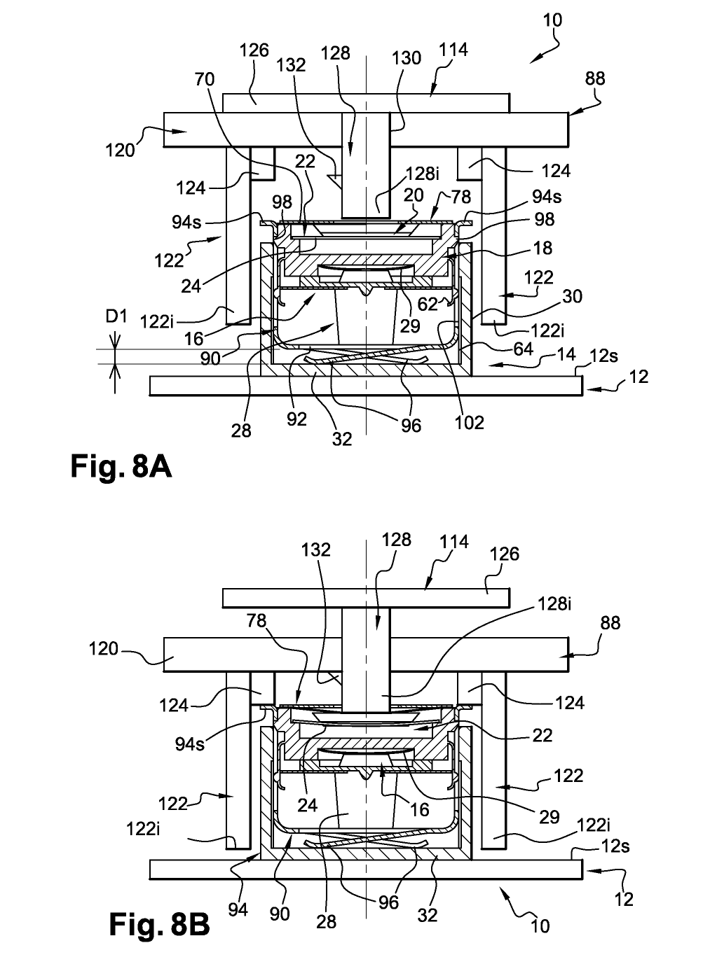

FIG. 6 illustrates another exemplary embodiment of the switch 10. According to this exemplary embodiment, the base 14 of the switch 10 may be made by over-moulding plastic around conductors 76 for connecting the switch 10 to the electrical tracks of the component-holder plate 12. The base 14 may also be made such that may support the fixed conductors 64 associated with the movable conductors 62. In this instance, the fixed conductors may be supported by the vertical uprights 30 of the base 14.

Consequently, the switch 10 may form an electronic component that is capable of being mounted on the top face 12s of the component-holder plate 12, the component-holder plate 12 then may include no holes 66 passing through it, such as those described in the embodiment represented in FIG. 2, which makes it possible to mount the electronic components on each of the two faces of the component-holder plate 12. The switching interrupter 16 may be made of several components that are held in position on the base 14 by a cage 78. The movable conductors 62 may attach to the plate 18 by over-moulding the material of the plate 18 around sections of the movable conductors 62.

Preferably, each movable conductor 62 may be made in a single piece with an electrical contact 26a, 26b of the detecting interrupter 22 or an electrical contact (not shown) for supplying the light source 50.

According to another aspect of the exemplary embodiment shown in FIG. 6, the top face 18s of the plate 18 may include a recessed reinforcement 80, or cavity, which defines several concentric and stepped bearing surfaces. A first surface 80a defined by this reinforcement may be radially external relative to the main vertical axis of the switch 10. The first surface 80a may be situated in a horizontal plate situated vertically beneath the horizontal plane of the top face 18s of the plate 18. This first surface 80a may form a carrying annular surface for the peripheral portion 34 of the blade 24 on which the peripheral portion 34 is pressing downwards. The first surface also may support at least one first electrical contact 26a (not shown in this figure), so that the blade 24 is permanently connected with this at least one first electrical contact 26a.

A second surface 80b defined by the reinforcement may be radially intermediate relative to the main vertical axis of the switch 10, and it may be situated in a horizontal plane situated vertically beneath the horizontal plane of the first surface 80a. This second annular surface 80b may support the second contacts 26b with which the central movable portion 36 of the blade 24 is capable of coming into contact in order to detect the contact of a control member on the top face 20s of the button 20.

Finally, a third surface 80c formed in the reinforcement may be radially internal relative to the main vertical axis of the switch 10, and it may be situated in a horizontal plane situated vertically beneath the horizontal plane of the second surface 80b. This third central surface 80c may support the light source 50 and the electrical contacts for connection of the light source 50. Because of the height difference between the first surface 80a and the second surface 80b, the plate 18 may hold the central portion 36 of the blade 24 at a distance from the second contacts 26b without any additional component of the detecting interrupter 22.

In addition, the first surface 80a may connect to the top face 18s of the plate 18 by a surface defining a cylindrical duct in which the blade 24 is received without horizontal clearance, making it possible to achieve a horizontal positioning of the blade 24 on the plate 18. The protective film 70 may also be received in the cylindrical duct connecting the top face 18s of the plate to the peripheral portion 34, and it presses downwards on the blade 24.

The switch 10 discussed above according to one or more exemplary embodiments may be designed to be used in an assembly (not shown) which comprises one or more switches 10 as described above, and a device capable of transmitting a visual or audible warning when a detection signal is established. For example, the assembly may include several switches 10 arranged so as to form a keyboard such as a digital keyboard with twelve “keys”, and a display screen on which several images are displayed, each image being associated with a switch 10.

When the assembly is at rest, that is to say when no switch according to the invention is actuated or touched by the control member, no detection signal and no switch path associated with the switches 10 may be established. The display screen may then display a first representation of each image associated with a switch 10. When the user wishes to actuate a particular switch 10, he may place a control member in contact with one of the switches 10 and the detecting interrupter 22 of this switch is then activated and the associated detection signal is activated.

In response to this detection signal, the display screen may modify the representation of the image associated with the switch 10 on which the control member is in contact. Therefore, by looking at the display screen, the user may know on which switch 10 the control member is in contact. If the switch 10 on which the control member is in contact is not the particular switch chosen by the user, the user may move the control member in order to place it in contact on the button 20 of another switch 10.

Each contact of the control member on another switch 10 may then cause the establishment of the detection signal associated with this other switch 10, so that the user is always informed of the relative position of the control member relative to the assembly of switches 10. When the control member is in contact with the particular switch chosen by the user, the user may then exert an actuation force causing the associated switching interrupter 16 to change state, in order to command a predefined action of an electronic apparatus connected to the switch 10.

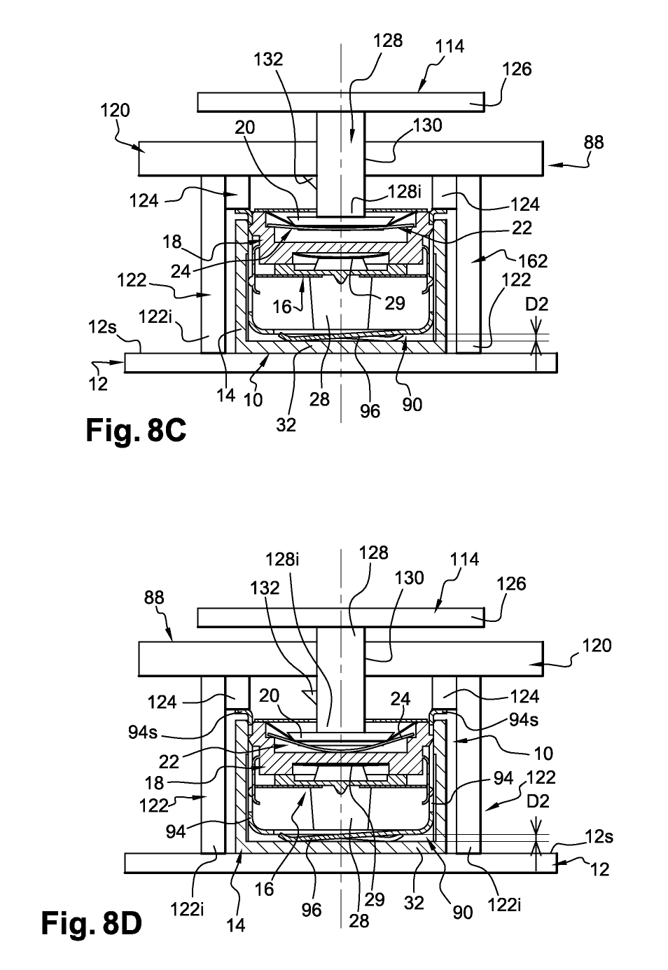

FIG. 7 illustrates another exemplary embodiment of the switch 10 which may be designed to form a module that may be mounted on the component holder plate 12 and that may be covered by an outer casing 88 mounted on the component holder plate 12. The switch 10 may also be designed so as to compensate the dimensional tolerances between the casing 88 and the components of the switch 10. According to this embodiment, the switch 10 may comprise an intermediate frame 90 supporting the movable plate 18 and the switching interrupter 16.

The intermediate frame 90 may be mounted on the base 14 of the switch 10 so as to be able to move by sliding vertically downwards relative to the base 14 when the casing 88 is mounted on the plate 12. The intermediate frame 90 may comprise a horizontal bottom 92 and two side walls 94 extending upwards from the extremities of the bottom 92. The top extremities 94s of the side walls 94 may fold outwardly and extend above the uprights 30 of the base 14. The bottom 92 of the intermediate frame 90 may comprise spring blades 96 which may incline downwardly. The spring blades 96 may press down on the top face of the bottom portion 32 of the base 14 so that the intermediate frame 90 may be urged upwards with respect to the base 14.

According to this embodiment, the intermediate frame 90 may support the plate 18, the detecting interrupter 22 and the switching interrupter 16. The detecting interrupter 22 may be supported by the plate 18. The top face 18s of the plate 18 may further comprise a recessed reinforcement 80 similar to the one described in the previous embodiment, with respect to FIG. 6. The peripheral portion 34 of the blade 24 may be carried by a first surface 80a of the reinforcement 80. The first surface may also support at least one first electrical contact 26a. A second surface 80b defined by the reinforcement may support the second contacts 26b with which the central movable portion 36 of the blade 24 may contact in order to detect the contact of a control member on the top face 20s of the top button 20.

The top button 20 may be covered by the protective film 70 so that it cannot move away from the switch 10 before the casing 88 is mounted on the switch 10. The top button 20 may also be in constant contact with the central portion 36 of the blade 24. The switching interrupter 16 may be disposed between the plate 18 and the bottom 92 of the frame 90. The switching interrupter 16 may revert with respect to the previous embodiments, that is to say that the button 28 may be on the lower part of the interrupter 16, and the contactor 29 may link to the plate 18.

Here, the contactor 29 may be a resiliently deformable dome like member capable of coming into contact with two electrical contacts (not represented) when the value of the actuation force applied on the contactor 29 is greater than the second threshold value. These two electrical contacts may be supported by the bottom face 18i of the plate 18. In order to allow the actuation of the switching interrupter 16, the plate 18 may move with respect to the frame 90 along the vertical axis of the electrical switch 10. When the plate 18 moves downwards with respect to the frame 90, that is to say when the actuation force is greater than the second threshold value, the contactor 29 of the switching interrupter 16 may collapse and the button 28 may compress. The contactor 29 and the button 28 may be elastically deformable so that each of them exerts an upright elastic effort on the plate 18 to return the plate 18 towards its upper position when the actuation force is released.

The plate 18 may be guided in translation with respect to the frame 90 by means of teeth 98 extending transversely from each longitudinal vertical end face 100 of the plate 18. The teeth 98 may be received in vertical notches 102 made in the vertical side walls 94 of the frame 90. When the plate 18 is its upper position, the teeth 98 may abut vertically against the top end of the notches 102 in order to maintain the button 28 and the contactor 29 of the switching interrupter 16 in a preloaded state and to maintain the plate 18 mounted on the frame 90. The switch may also comprise a cage 78 surrounding the plate 18, the detecting interrupter 22, the switching interrupter 16 and the protective film 70 in order to maintain the detecting interrupter 22, the switching interrupter 16 and the protective film 70 linked to the plate 18.

The cage 78 may be a folded metal sheet that may comprise a top horizontal portion 104, a bottom horizontal portion 106 and vertical transversal portions 108. The top portion 104 may comprise a central opening 110 traversed by a push button 114 linked to the casing 88 to actuate the detecting interrupter 22. The bottom portion 106 may comprise an opening 110 traversed by the button 28 of the switching interrupter 16. The button 28 may comprise a flat portion 116 which is compressed between the plate 18 and the bottom portion 106 of the cage 78 for the assembly of the button 28 with the plate 18.

The electrical connection of the contacts 26a, 26b of the detecting interrupter 22 and the electrical connection of the contacts of the switching interrupter 16 with the component holder plate 12 may be achieved by movable conductors 62 that contact fixed conductors 64 supported by the base 14. Each of the movable conductors 62 may be associated with one contact of the detecting interrupters 22, or of the switching interrupter 16, and they may be movable through the notches 102 of the side walls 94 of the frame 90 to contact the associated fixed conductors 64. As discussed above, the switch 10 may be covered by a casing 88 which is mounted on the plate 12.

The casing 88 may comprise a horizontal top plate 120 located vertically above the switch 10. The casing 88 may comprise vertical feet 122 extending downwards from the top plate 120. The lower end 122i of each foot 122 may be aimed to be in contact with the top face 12s of the plate 12. The casing 88 may also comprise rims 124 extending downwards from the top plate 120 and which may be aimed to push down on the top extremity 94s of each side wall 94 of the frame 90 when the casing 88 is mounted on the component holder plate 12.

The push button 114 may be slidably mounted on the casing 88. The push button 114 may comprise a horizontal top portion 126 on which the user exerts the control action, and a vertical shaft 128 transmitting the control action directly to the button 20. The shaft 128 may traverse an associated hole 130 of the top plate 120, and the lower end 128i of the shaft 128 may press down on the button 20. The shaft 128 may also comprise a finger 132 located under the top plate 120, and which may prevent the push button 114 from being removed from the casing 88.

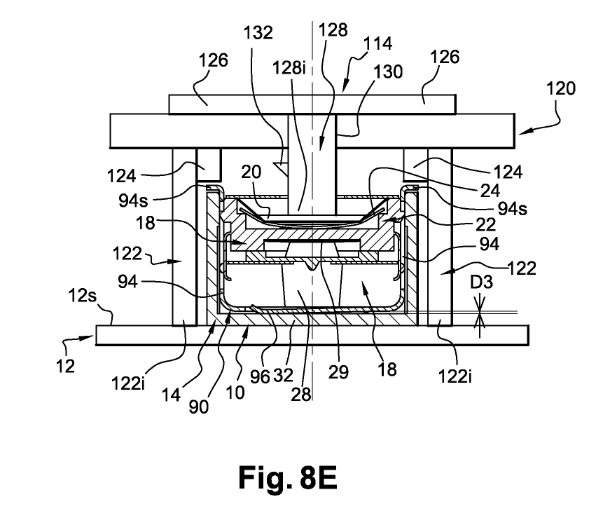

FIGS. 8A to 8E illustrate different steps of an assembly of the casing 88 on the plate 12 and of the actuation of the switch 10. In FIG. 8A, the switch 10 may be mounted on the plate 12 and the casing may be positioned above the switch 10 such that it does not contact the switch or the plate. When the switch 10 is in an initial position, the detecting interrupter 22 and the switching interrupter 16 may not be actuated. In this position, the spring blades 96 of the frame 90 may maintain the frame 90 in an uppermost position such that the bottom 92 of the frame 90 may be located at a first distance D1 from the bottom portion 32 of the base 14.

In an intermediate step of the mounting of the casing 88 as shown in FIG. 8B, the casing 88 may contact the frame 90. In this relative position, the rims 124 may come in contact with the top extremities 94s of the side walls 94 of the frame 90, and the lower end 122i of each foot 122 may be away from the top face 12s of the plate 12. In this position, the frame 90 may not be pushed downwards by the rims 124. Moreover, a preloading of the detecting interrupter 22 may be achieved such that the push button 114 cooperates with the button 20 to produce an initial elastically deformation of the blade 24 sufficient enough such that the finger 132 of the push button 114 is in upwards abutment against the top plate 120 and such that the detecting interrupter 22 is not activated.

A proper preloading of the detecting interrupter 22 may be achieved by a setting of the vertical distance between the lower end 128i of the shaft 128 and the end faces of the rims 124.

When the casing 88 is further moved downwards from this intermediate position until it comes in contact with the plate 12, as shown in FIG. 8C, the casing 88 may push down the frame 90 as the rims 124 may push down on the top extremities 94s of the side walls 94. The plate 18, the detecting interrupter 22 and the switching interrupter 16 may then be simultaneously urged downwards such that neither of the detecting interrupter 22 and the switching interrupter 16 is activated. The spring blades 96 may elastically deform in response to this downwards displacement of the frame 90.

In the position shown in FIG. 8C, the bottom of the frame 90 may be at a second distance D2 from the bottom portion 32 of the base 14, which may be smaller than the first distance D1. The casing 88 may then be mounted in a position in which the switch 10 may be used according to the invention. The use of the movable frame 90 and the spring blades 96 may also allow compensating dimensional tolerances in manufacturing of every part of the switch 10 and the casing 88 along the vertical axis.

In an apparatus including several switches 10 according to the invention, having a single casing 88 with multiple push buttons 114 directly associated with the switches 10, the embodiment shown in FIG. 8C may permit a positioning of each push button with respect to the associated switch such as to eliminate potential vertical play between each push button and the associated button, and so that the detection interrupter 22 is not accidentally activated. When a user exerts a control action on the top portion of the push button, the blade 24 may first deform such that the detection interrupter 22 may activate when the value of the control action is greater than the first threshold value, as shown in FIG. 8D.

As discussed above, the switching interrupter 16 may activate when the value of the control action becomes greater than the second threshold value. The plate 18 then may move downwards with respect to the frame 90 until the contactor 29 collapses. During the consecutive activation of the detection interrupter 22 and of the switching interrupter 16, the push button 114 may move downward with respect to the casing 88. From the point when the switching interrupter 16 is activated, an additional downward movement may compress the contactor 29 with a greater force.

In order to reduce damages on the contactor 29, the plate 18, the button 28 and the frame 90 may move downward together with the push button 114 during this consecutive actuation causing another deformation of the spring blades 96 until the top portion 126 of the push button abuts against the top plate of the casing 88, as shown in FIG. 8E. At this point, the bottom of the frame 90 may be at a third distance D3 from the bottom portion 32 of the base, ensuring that the contactor 29 is not fully compressed by the push button 114.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An electrical switch comprising:
a supporting base;
a top button mounted to the supporting base so as to be movable by sliding vertically relative to the supporting base, wherein the top button has a top face configured to receive a first force for actuating the electrical switch, the first force being exerted by a control member;
a detecting interrupter mounted to the top button configured to detect contact of the control member on the top face as well as to establish a signal representative of any detection of the contact of the control member on the top button when the first force exerted by the control member is greater than or equal to a first threshold value, the detecting interrupter comprising:
a blade configured to deform elastically under the top button to establish the signal and further configured to exert a resistance force on the top button, wherein the resistance force increases continuously while the first force is exerted by the control member,
a plate mounted to the detecting interrupter and configured to be movable by sliding vertically relative to the supporting base; and
a switching interrupter mounted to the supporting base to which the first force is transmitted indirectly by the plate, wherein the switching interrupter is configured to establish a switch path when the first force is greater than or equal to a second threshold value, wherein the second threshold value is greater than the first threshold value.

2. The electrical switch of claim 1, wherein the top button is attached to the blade such that the blade generates a horizontal positioning of the top button relative to the plate and a movement guidance of the top button vertical to the plate.

3. The electrical switch of claim 1, wherein the detecting interrupter further comprises at least two electrical contacts mounted on the plate, wherein the at least two electrical contacts are configured to be electrically connected by the blade when the detection signal is established.

4. The electrical switch of claim 3, wherein the blade comprises a peripheral portion mounted to the plate and a central portion mounted to the top button.

5. The electrical switch of claim 4, wherein the peripheral portion of the blade comprises at least one lug which is connected to a first of the at least two electrical contacts, and wherein the central portion of the blade comprises at least one bearing finger configured to contact a second of the at least two electrical contacts.

6. The electrical switch of claim 1, wherein the top button is further configured to move into abutment against the plate by deflecting the blade when an amplitude of the first force is greater than or equal to the first threshold value such that the first force is transmitted to the switching interrupter via the plate.

7. The electrical switch of claim 1, wherein any movement of the plate is guided by the supporting base.

8. The electrical switch of claim 7, wherein the switching interrupter is configured to produce a tactile sensation during actuation, the tactile sensation being transmitted to the top button by means of the plate.

9. The electrical switch of claim 1, wherein the plate, the detecting interrupter and the switching interrupter are mounted on an intermediate frame configured to move vertically with respect to the supporting base.

10. The electrical switch of claim 9, further comprising elastic components mounted to both the supporting base and the intermediate frame and configured to push the intermediate frame away from the supporting base.

11. The electrical switch of claim 10, wherein the plate is configured to move vertically with respect to the intermediate frame.

12. A switch assembly comprising:
at least one switch mounted on a holder plate, the at least one switch comprising:
a supporting base,
a top button mounted to the supporting base so as to be movable by sliding vertically relative to the supporting base, wherein the top button has a top face configured to receive a first force for actuating the electrical switch, the first force being exerted by a control member,
a detecting interrupter mounted to the top button configured to detect contact of the control member on the top face as well as to establish a signal representative of any detection of the contact of the control member on the top button when the first force exerted by the control member is greater than or equal to a first threshold value, the detecting interrupter comprising:
a blade configured to deform elastically under the top button to establish the signal and further configured to exert a resistance force on the top button, wherein the resistance force increases continuously while the first force is exerted by the control member,
a plate mounted to the detecting interrupter and configured to be movable by sliding vertically relative to the supporting base, and
a switching interrupter mounted to the supporting base to which the first force is transmitted indirectly by the plate, wherein the switching interrupter is configured to establish a switch path when the first force is greater than or equal to a second threshold value, wherein the second threshold value is greater than the first threshold value, and
a switch case configured to enclose the at least one switch, the switch case further configured to mount on the holder plate such that the switch case pushes downwards on an intermediate frame.

13. The assembly of claim 12, wherein the switch case comprises a push button configured to slide vertically and receive an actuation force and transfer the actuation force to the top button.

14. The assembly of claim 13 further comprising at least one of a visual warning device or an audio warning device both of which are configured to produce a warning signal when the detection signal is established.

15. The assembly of claim 14, wherein the visual warning device comprises a display screen configured to change an image representation when the detection signal is established.
